(19) United States
(12) Patent Application Publication
(10) Pub. No.: US 2009/0221333 A1
(43) Pub. Date: Sep. 3, 2009

(54) Cell Phone Device

(75) Inventor: Charles E. Harvey, Fort Myers, FL (US)

Correspondence Address: GROSSMAN, TUCKER, PERREAULT & PFLEGER, PLLC, 55 SOUTH COMMERICAL STREET, MANCHESTER, NH, 03101, US

(73) Assignee: Charles E. Harvey, Fort Myers, FL (US)

(21) Appl. No.: 12/041,340

(22) Filed: Mar. 3, 2008

(51) Int. Cl. H04M 1/00

(52) U.S. Cl. 455/575.1

(57) ABSTRACT

A support for a mobile phone or other device allows the phone to be suspended above the work surface. The support includes a platform hinged to a connector and a base hinged to an opposing end of the connector. Memory hinges can allow the device to support the phone in a variety of orientations.

### BACKGROUND

1. Field of Invention

The invention relates generally to accessories for consumer electronics and specifically to a cell phone stand.

2. Discussion of Related Art

Mobile phones (cell phones) can frequently be accompanied by accessories that are designed to improve the usefulness of the phone. For instance, phones may include cases, covers, holsters, protectors and mounts for securing the phone inside a vehicle. Charging stands, or cradles, are also available for desktop use and may be used to charge a phone or synchronize it with a PC. These accessories may be available through cell phone manufacturers or through third party suppliers.

### SUMMARY OF INVENTION

The subject matter of this application may involve, in some cases, interrelated products, alternative solutions to a particular problem, and/or a plurality of different uses of a single system or article.

In one aspect, the invention includes a support for a cell phone, the support comprising a first platform including a fastener for securing a cell phone, a support member having a first end and a second end, the first end pivotally attached to the first platform, and a substantially planar base pivotally attached to the second end of the support member, the base constructed and arranged to be placed on a horizontal surface.

### BRIEF DESCRIPTION OF DRAWINGS

In the drawings,

FIG. 1 is a side view of one embodiment of the invention;

FIG. 2 is a side view of the device of FIG. 1 with the device in a collapsed configuration;

FIG. 3 is an end view of the device of FIG. 1 in a collapsed configuration;

FIG. 4 is a bottom view of the device of FIG. 1 in a collapsed configuration;

FIG. 5 is a back view of the device of FIG. 1 in the extended configuration of FIG. 1;

FIG. 6 is a front view of the device of FIG. 1 in the extended configuration of FIG. 1;

FIG. 7 is a bottom view of the device of FIG. 1 in the extended configuration of FIG. 1;

FIG. 8A is a view of the back of one embodiment of a mobile phone;

FIG. 8B provides an illustration of the mobile phone of FIG. 8A mounted on the embodiment of FIG. 1;

FIG. 9A is a view of the back of another embodiment of a mobile phone;

FIG. 9B provides an illustration of the mobile phone of FIG. 9A mounted on the embodiment of FIG. 1;

FIG. 10A is a view of the back of another embodiment of a mobile phone; and

FIG. 10B provides an illustration of the mobile phone of FIG. 10A mounted on the embodiment of FIG. 1.

### DETAILED DESCRIPTION

In one aspect of the invention a stand for a cell phone is provided. The stand may be used to support one or more different mobile phone models including candy bar, clam shell, flip-phone and slider styles. The phone can be supported by the stand in a way that allows the phone display to be properly positioned for viewing while sitting at a desk. The display may also be at a convenient height and angle for using a stylus. The stand may also allow the phone to be positioned so that charging cables, synchronizing cables and other peripherals can be plugged into the bottom edge of the phone while it is secured in the stand. Cables and peripherals may also be plugged into the sides or top of the phone as the stand need not interfere with these edges.

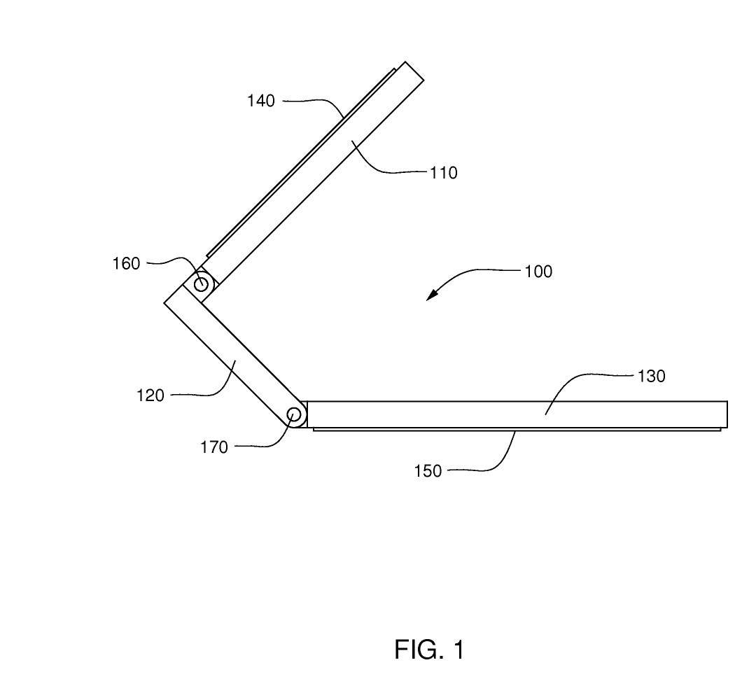

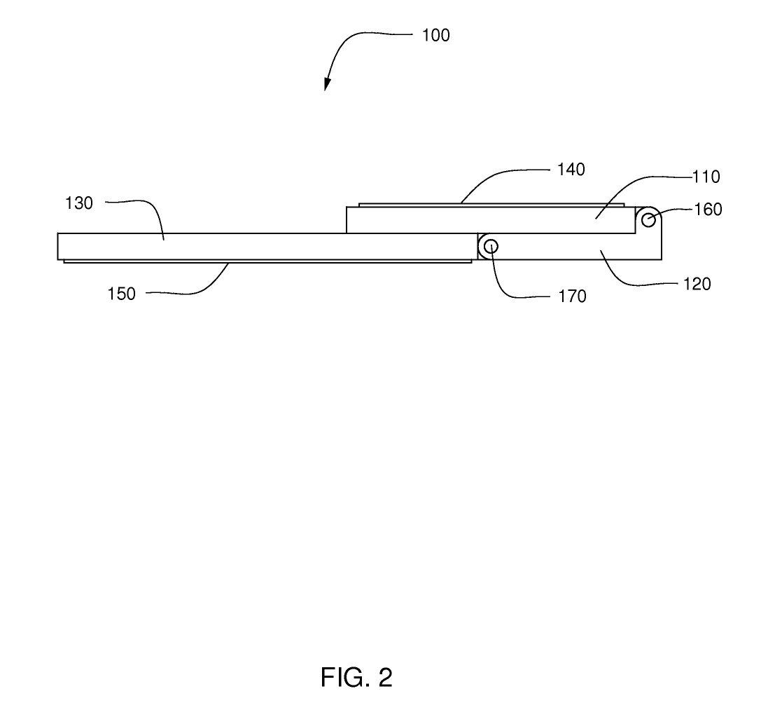

One embodiment of a cell phone support is illustrated in FIGS. 1 and 2. FIG. 1 provides a side view of the support 100 (stand) without a cell phone attached. FIG. 2 provides a side view of the same support in a collapsed position. Platform 110 is attached to connector 120 via hinge 160. Connector 120 is attached to base 130 via hinge 170. Each of the hinges provides for pivotal rotation about the hinge. Platform 110 includes phone interface 140 that can help to maintain the position of the phone when placed on the platform. Platform 110 may have a width that is substantially equal to the width of a cell phone that it is designed to support. Its length may also be about the length of a cell phone or the length of a closed cell phone. Phone interface 140 may securely attach to the phone or may help to prevent the phone from slipping off the platform. For instance, interface 140 can be a non-slip pad, a magnet or one side of a hook and loop fastener. Base 130 may also include a pad 150 (or multiple pads or feet) that may help prevent the base from sliding and may protect the desk or table surface from scuffing. Pad 150 may also be a non-slip pad. Base 130 may be the same length or longer than platform 110 and may have a similar width, although in some embodiments the base may be narrower or wider than platform 110. Base 130 may also include a clamp or other device for securely fixing support 100 to a desk, table or other surface.

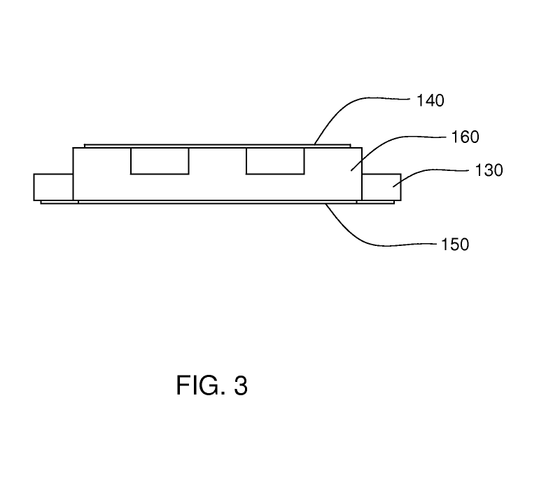

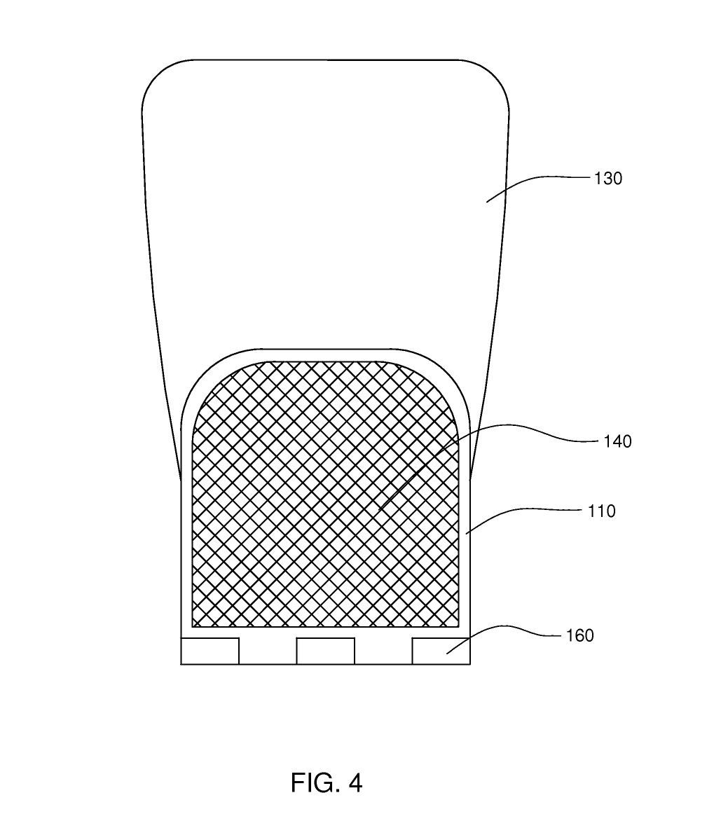

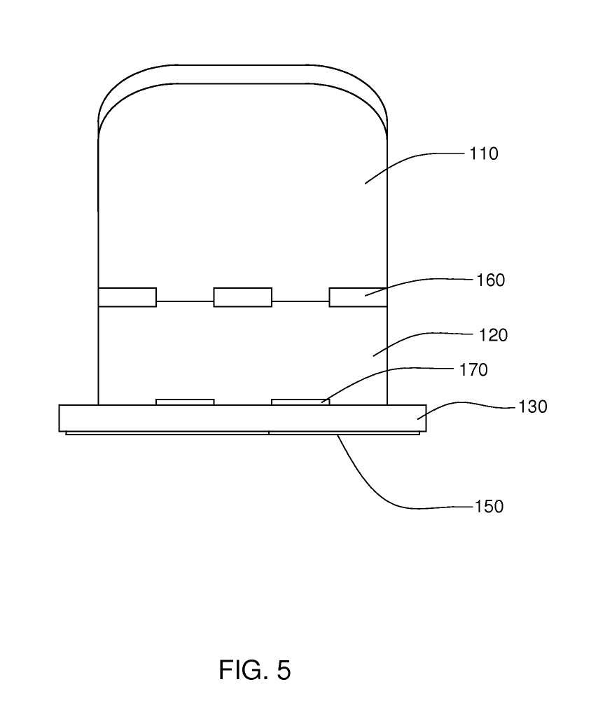

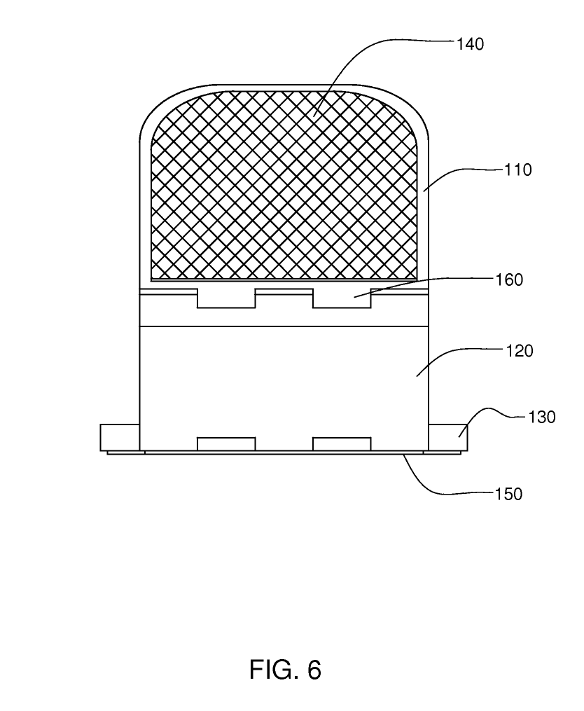

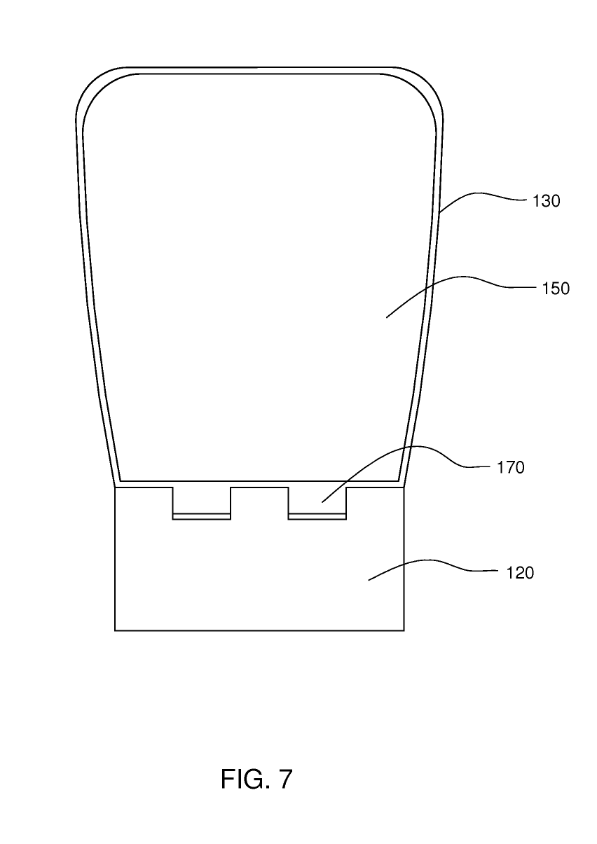

As shown in FIG. 2 the support may be folded to a flat position for storing and/or shipment. Phone interface 140 is exposed so that a phone may be mounted on the interface even when the support is in this collapsed position. FIG. 3 provides a right side view of the device of FIG. 2, and FIG. 4 provides a top view of the same device. FIG. 7 is a bottom view of the device showing pad 150. FIG. 5 provides a right side view of the extended configuration of FIG. 1 while FIG. 6 provides a left side view of the device in the same position. Typically, the device will be used in the extended configuration.

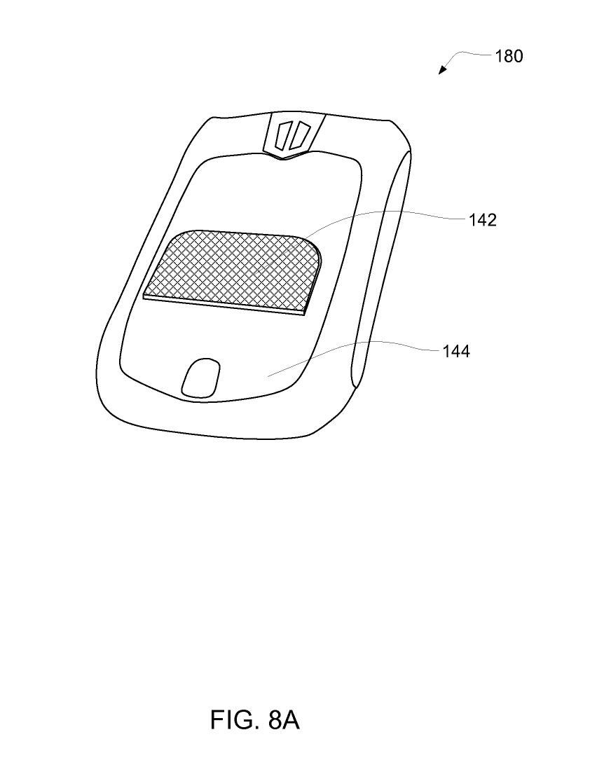

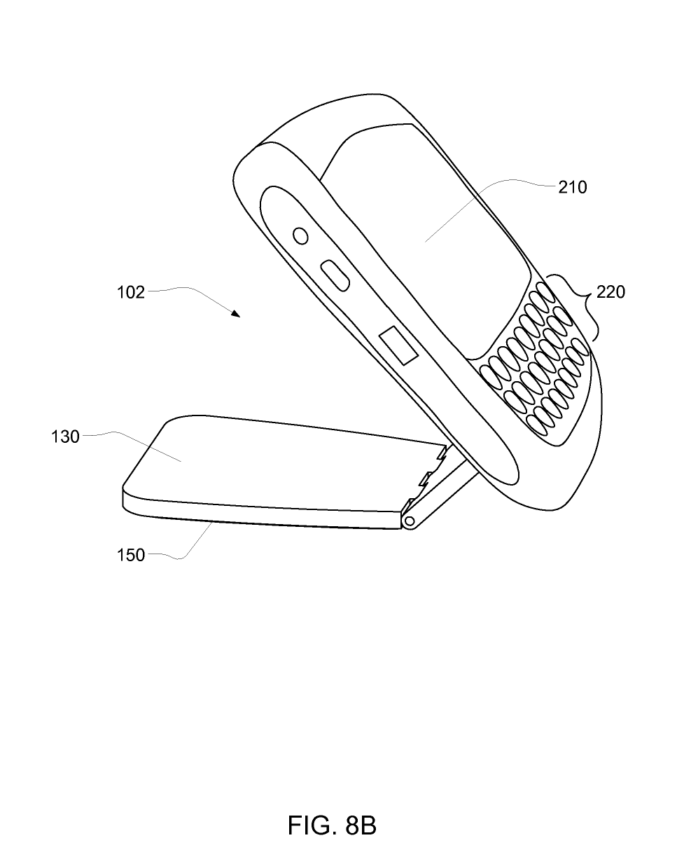

A smartphone, specifically BLACKBERRY® device 180 is shown in FIGS. 8A and 8B. The phone may be securely attached via a fastener or, alternatively, can rest on the stand without being attached. FIG. 8A shows the back of the device and includes interface 142 that can interact with phone interface 140 to secure the BLACKBERRY to the stand. The interface can prevent the phone from sliding off of the support when positioned as indicated in FIG. 8B. Interface 142 may be a non-slip pad that provides friction with phone interface 140 to prevent the phone from sliding off of stand 100. In other embodiments interface 142 may be a magnet or a magnetic component, a hook and loop fastener, a clip, or other device to attach the phone to the stand. Interface 142 can be a portion of a connector that is permanently or temporarily attached to the phone. A permanently attached interface may be, for example, glued to, welded to, molded into or otherwise attached so that the interface is not readily removable from the back of the phone. In one set of embodiments, interface 142 is permanently attached to a removable portion of the phone such as battery compartment cover 144. Battery compartment cover 144 may be manufactured with interface 142 molded in or otherwise attached to the cover. For instance, a snap, a clip, a slide or a magnet may be molded directly into the cover during the manufacturing process. This may provide for a more finished appearance than when an interface is attached by the customer. Customized covers may be provided, for example, by the OEM or by aftermarket providers.

When the support is extended as shown in FIG. 1 or FIG. 8B, the phone can be mounted so that display 210 is at an optimum angle for viewing by the user. This angle can be adjusted by opening or closing either one or both of hinges 160 and 170. In relation to the surface on which the support is located the phone may be supported at any angle in the range of 0 to 90 degrees. Preferred ranges may be, for instance, from 30 to 60 degrees or from 40 to 50 degrees from horizontal. In the same manner, an input interface, such as keypad 220, may also be oriented for optimum use at a desk or other horizontal surface. Friction pad 150 can help secure the position of the support so that when keypad 220 is pressed the phone remains stable and doesn't slide across the surface on which it rests.

The configuration of the support as shown in FIG. 1 allows all outer edges of the phone—top, bottom and both sides—to be exposed and accessible. For example, the bottom edge of the phone may be more than 1 cm, more than 2 cm or more than 3 cm above the surface on which the support is resting. Therefore, accessories such as charging cables, syncing cables, earphones and memory cards can be attached and unattached while the phone is supported by the stand. Furthermore, elevation may allow a speaker on the mobile phone to be positioned so that it is unhindered by the work surface or by the stand. This elevation can be achieved, for example, by the use of the three component stand as shown in FIG. 1. Platform 110 may also include through holes that may be used to provide access to ports, speakers and other peripherals that may be accessible only from the back of the phone. For instance, platform 110 may include a hole that can be aligned with a speaker that is mounted on the back of the phone.

Base 130 provides a secure support and may be weighted in order to aid in balancing a heavy mobile phone or other device. Connector 120 joins base 130 with platform 110 and can provide vertical height to position platform 110 above the work surface. This configuration can provide for the elevation of the mobile phone while maintaining a comparatively compact form for the stand.

Hinges 160 and 170 provide for rotation of connector 120 and platform 110 around their respective axes. Hinge 160 and hinge 170 may be of the same type but they need not be. These hinges may be “memory” hinges. As used herein, memory hinges are hinges that can maintain their selected position under the weight of a mobile phone. Thus, if the components of the support are adjusted to the configuration shown in FIG. 1, the support can maintain this configuration after placement of a mobile phone on platform 110. The support may be held in position via friction hinge, ratchet hinge or other assembly that is able to retain a selected position with the weight of a device resting on the support.

In some embodiments, one or more of hinges 160 and 170 may open to 90 degrees, 180 degrees or 360 degrees. Preferably, the range of motion is adequate to permit the stand to collapse into a flat position as shown in FIG. 2. Additional hinges may be used to further increase the range of motion. As shown in the embodiment in FIG. 1, hinges 160 and 170 allow support 100 to extend into a flexible configuration where platform 110 and base 130 can be oriented to form a “U-shape,” an “L-shape” or any intermediate configuration. Although in some embodiments support 100 can be configured in a “Z-shape,” in other cases support 100 need not bend into a Z-shape as this requires additional hinge mobility and may not improve utility.

When a mobile phone or other device is in position on the stand as shown in FIG. 8B, 9B or 10B, for example, the center of gravity of the phone/stand assembly 102 should be over base 130 to help prevent the assembly from tipping forward. In some embodiments, the center of gravity is over a central portion of base 130. This force may help in preventing sliding of the assembly across the work surface when keypad 220 is pushed, when a touch screen is used, or when cords or other peripherals apply a force moving the assembly in one direction or another. The center of gravity may be adjusted, for example, by changing the position of phone 180 along platform 110, by changing the angle of lower hinge 170 and/or by changing the angle of upper hinge 160.

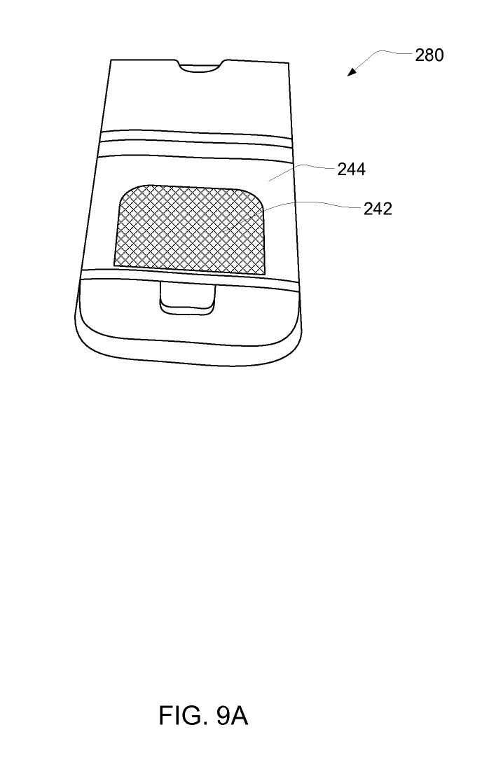

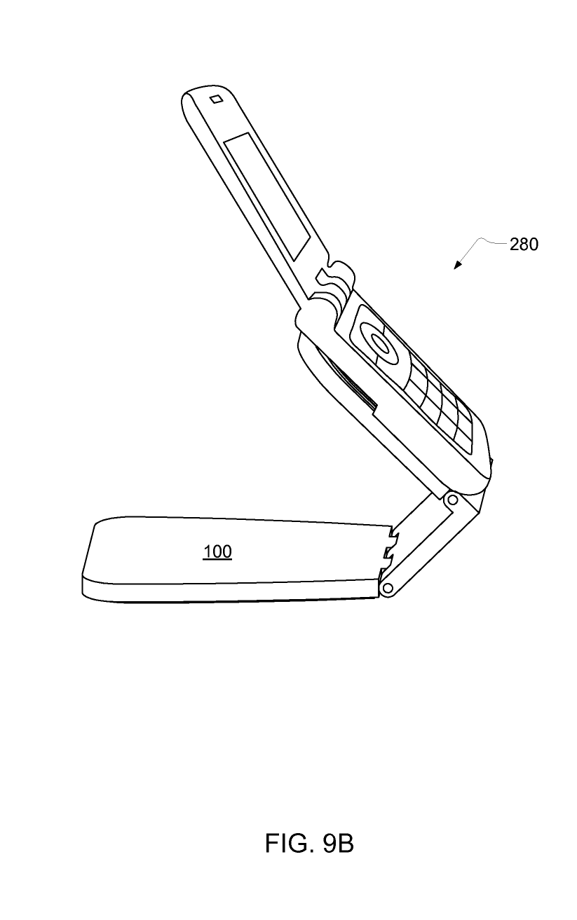

As shown in FIGS. 8A through 10B the same stand may be used with a variety of phones and PDAs. For instance, FIG. 9A provides a view of the back of a flip-phone style mobile phone. Mobile phone 280 includes battery cover 244 and interface 242 that may be used to secure the phone to stand 100. Interface 242 may be, for example, one side of a hook and loop fastening system. As shown in FIG. 9B, phone 280 may be in an open position on stand 100. Alternatively, the phone may be on the stand in a closed position and may be opened and closed while being held in place by the fastener. This allows the phone to be answered while in place on the stand.

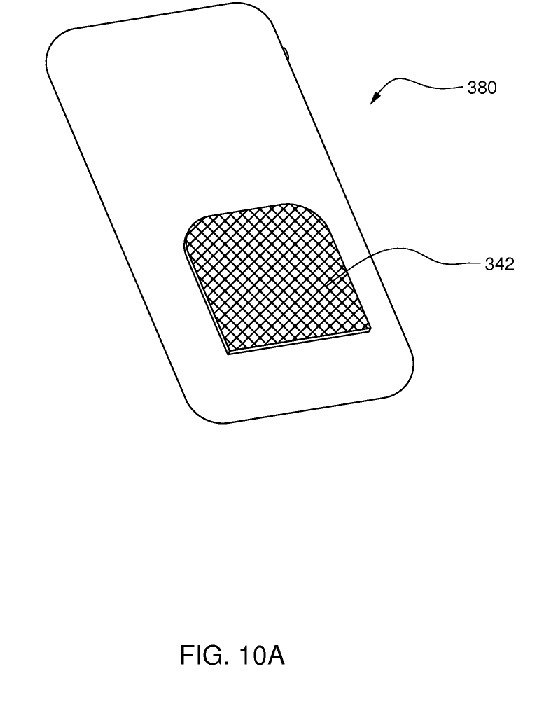

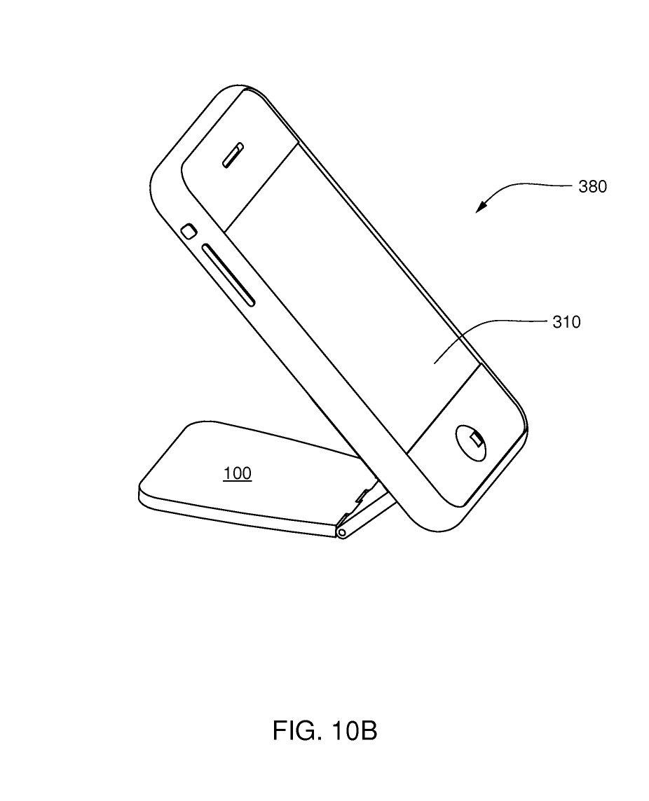

FIGS. 10A and 10B illustrate the use of stand 100 with a device such as an i-Phone® 380. The phone may include interface 342 that can form part of a fastening system to secure the phone to the stand. Phone 380 is suspended off of the desk surface and ports are available for memory cards, cables and other peripherals. Touch screen 310 can be activated and used while phone 380 is secured by the stand. Phone 380 can be optimally angled for proper viewing and most or all phone functions can be activated without removing the phone from the stand. The center of gravity of phone 380 is substantially over the middle of stand 100 and can help in preventing phone 380 from being tipped over when using or attaching cables or other peripherals. Pad 150 (on the bottom of stand 100) may be helpful in preventing the sliding of the device when different forces are applied to the phone.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified, unless clearly indicated to the contrary.

All references, patents and patent applications and publications that are cited or referred to in this application are incorporated in their entirety herein by reference.

What is claimed is:

1. A support for a cell phone comprising:
a first platform including a fastener for securing a cell phone;
a support member having a first end and a second end, the first end pivotally attached to the first platform; and
a substantially planar base pivotally attached to the second end of the support member, the base constructed and arranged to be placed on a horizontal surface.

2. The support of claim 1 wherein the first platform is attached to the support member via a memory hinge.

3. The support of claim 1 wherein the base is attached to the support member via a memory hinge.

4. The support of claim 1 wherein the first platform can be fixed in a position about 90 degrees to the support member and wherein the base can be fixed in a position between 90 and 180 degrees to the support member.

5. The support of claim 1 wherein the first platform can be fixed in a position of about 45 degrees with respect to the base.

6. The support of claim 5 wherein the support holds a cell phone in a position wherein the cell phone display is at an angle of about 45 degrees with respect to horizontal.

7. The support of claim 1 wherein the fastener comprises a hook and loop fastener.

8. The support of claim 1 wherein the fastener comprises a magnet.

9. The support of claim 1 wherein the support is constructed and arranged so that the first platform and the base can be angled inwardly toward each other.

10. The support of claim 1 wherein the support can be folded flat so that the first platform, the base and the support member are parallel to each other.
